(19) United States
(12) Patent Application Publication
(10) Pub. No.: US 2009/0039607 A1
(43) Pub. Date: Feb. 12, 2009

(54) Saucer load transporter

(76) Inventors: James R. Feeney, Holmdel, NJ (US); Elizabeth M. Feeney, Holmdel, NJ (US)

Correspondence Address: Charles I. Brodsky, 2 Bucks Lane, Marlboro, NJ, 07746, US

(21) Appl. No.: 11/891,020

(22) Filed: Aug. 9, 2007

(51) Int. Cl. B62B 11/00

(52) U.S. Cl. 280/18.1

(57) ABSTRACT

Large, awkward, heavy objects are made more easily transportable when placed on the rounded seat of a concavely-shaped saucer body, pullable by a user via a rope extension arrangement connected at a pair of adjacent apertures on a front side section of the saucer body.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to a person's transporting large, awkward, heavy objects about, in general, and to a person's moving such objects from a car to a backyard or from place-to-place around a backyard, in particular.

2. Description of the Related Art

As is well known and understood, wheelbarrows are typically employed to transport these cumbersome objects. Tracing its history to ancient China, the common wheelbarrow is a small hand-propelled vehicle, usually with just one wheel, designed to be pushed and guided by one person using two handles to the rear. Intended to distribute the weight of the load between the wheel and the operator so as to enable the convenient carrying of heavier and bulkier loads than would be possible were the weight to be carried entirely instead by a user, use of the wheelbarrow is common in the construction industry and in gardening.

Although considered to be simple, unmotorized, effective vehicles for one person to carry and move a heavy load, one who uses a wheelbarrow quickly comes to the realization that several factors may lessen their effectiveness. First, the wheels (similar to bicycle tires complete with inner tubes), need to be properly inflated. Second, the load to be carried must be substantially centered, front-to-back and side-to-side in order to prevent the wheelbarrow from tipping over. Third, the terrain needs to be of a type that can be comfortably traversed. Simply stated, even with a properly inflated wheel, even with a properly centered load, wheelbarrows are not very effective in transporting these large, awkward heavy objects across grass, dirt, mud, sand, and gravel—and especially when confronted with upwards and sideways lying slopes. As has readily been experienced in these manners of use, the wheelbarrow gets bogged down and stuck, tears up the lawn or ground when being pushed, or just tilts over.

Moreover, moving a tree purchased from a nursery from a car to the backyard, for example, may turn out to be an almost insurmountable task when the person pushing the wheelbarrow is of small stature; or when the backyard where the tree is to be planted is a measurable distance away, where the grading of the site is upward from front to back, or where a curb at the street must first be crossed. Even if this were not the case, however, and where the transportation is to be along a level concrete walk, still the lifting and pushing of these cumbersome objects puts a strain on a user's back.

### OBJECTS OF THE PRESENT INVENTION

It is an object of the present invention, therefore, to provide a new and improved manner of transporting large, awkward heavy objects comfortably and easily across these types of terrain, up-and-over curbs that may be present, and along level concrete walks as well.

It is also an object of the invention to provide an alternative to a wheelbarrow as a carrier useful for the household gardener to carry moderate loads.

It is another object of the invention to provide a manner of transporting cumbersome loads by means of an inexpensive, lightweight easily storable, alternative to a wheelbarrow, which is devoid of almost anything that might go wrong—as with the rusting of the steel support legs of a wheelbarrow or of its steel bed, or its rubber wheel going flat.

### SUMMARY OF THE INVENTION

As will become clear from the following description, the load transporter of the present invention includes a concavely-shaped saucer body having a rounded seat section with a preferably smooth underside to permit the transporter to glide, spin and turn as it is moving. To provide guidance of direction, the transporter of the invention includes a pull-rope traversing through a pair of adjacent apertures in a side section of the saucer passing through a tubular hand-grip overlying a knot where the rope length is tied. The transporter of the invention, in one embodiment, will also be seen as having a raised “back section area” as compared to a “front section area” and to have provided slots, additionally, for attachment of the rope in a further “debris carrying” mode.

As will be appreciated by those skilled in the art, by employing a rounded body section, the transporter of the invention is devoid of any edges that might hang up on a tree, lamp pole or fence post when being pulled, or to the edge of any outdoor deck that might be encountered (that is, the transporter simply skates around the obstruction and does not tend to snag). Also, by having a relatively shallow depth, with the smooth bottom surface, the transporter of the invention essentially just glides along as its rope is being pulled, giving rise to the employment of the term “GardenGlide” in identifying one aspect of use of the invention. Being manufactured of a high density, injected molded plastic, the transporter of the invention can easily and simply be “stored” away after use. And, with the smooth plastic surface provided to the bottom of the round transporter, its usage in moving these heavy objects about is predominantly “mar-free”, in not damaging the terrain being traversed even though the load may be quite heavy.

As will thus be understood, the uses are myriad—typical ones including carrying bags of top soil, mulch, and fertilizer from a car to the backyard, transporting decorative bricks and stone to be used in building an outdoor patio, carrying trees, shrubs and bushes, and in pulling dead branches and overgrowth from the backyard along to the street for curb-side pick up. Also, just in removing the dirt dug from the ground in making the hole where the tree, shrub or bush is to be planted.

In all respects, having the pullable, saucer-like transporter permits a snag-free movement of whatever is to be carried, whether uphill or downhill, over grass, dirt, mud, sand, gravel and even concrete, that may be encountered in moving large, awkward, heavy objects. Generally, then, the present invention relates to the ability to move these cumbersome objects about, whether from a car to the backyard, throughout the backyard, and wherever.

### BRIEF DESCRIPTION OF THE DRAWINGS

These and other features of the present invention will be more clearly understood from a consideration of the following description, taken in connection with the accompanying Drawings, in which:

FIGS. 1a and 1b are top and left side views of a first embodiment of a saucer load transporter in accordance with the invention, its bottom and right side views being mirror images;

FIGS. 2a and 2b are top and left side views of a second embodiment of a saucer load transporter according to the invention, also with its bottom and right side views being mirror images;

FIGS. 3a and 3b are views helpful in an understanding of the construction of “back” and “front” section areas of the saucer transporter shown in FIGS. 1a and 1b, and 2a and 2b;

FIGS. 4a-4c are section-views helpful in an understanding of a “front” section area rope re-enforcement for the embodiments of FIGS. 1a and 1b; and

FIGS. 5a-5c are section-views helpful in an understanding of a “back” section area rope re-enforcement for the embodiments of FIGS. 2a and 2b.

### DETAILED DESCRIPTION OF THE INVENTION

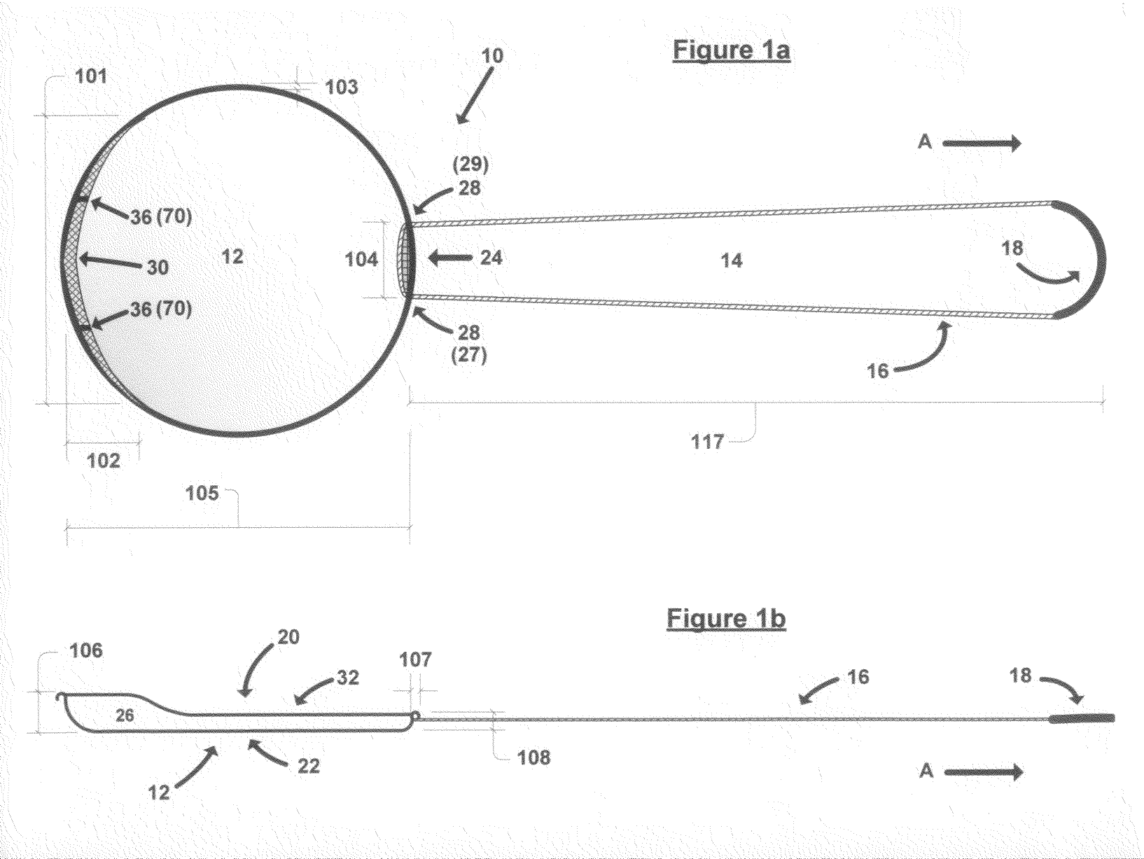

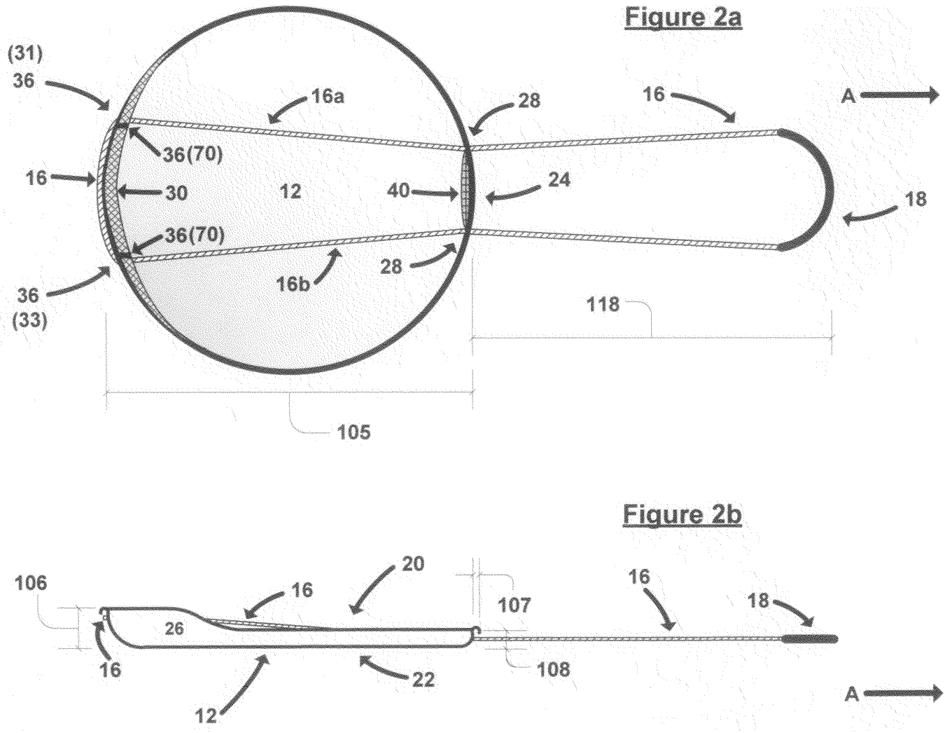

In the Drawings, the saucer load transporter of the invention is shown at 10 as having a concavely-shaped saucer body 12 and a rope pull extension arrangement 14 including a knotted rope 16 and a tubular hand-grip 18. Preferably of a nylon composition, the rope 16 extends through the hand-grip 18, selected of a length equal to at least 2 hand-spans of a typical user. In the views of FIGS. 1a and 2a, it will be understood that the ends of the rope 16 are knotted together within the length illustrated by the hand-grip 18.

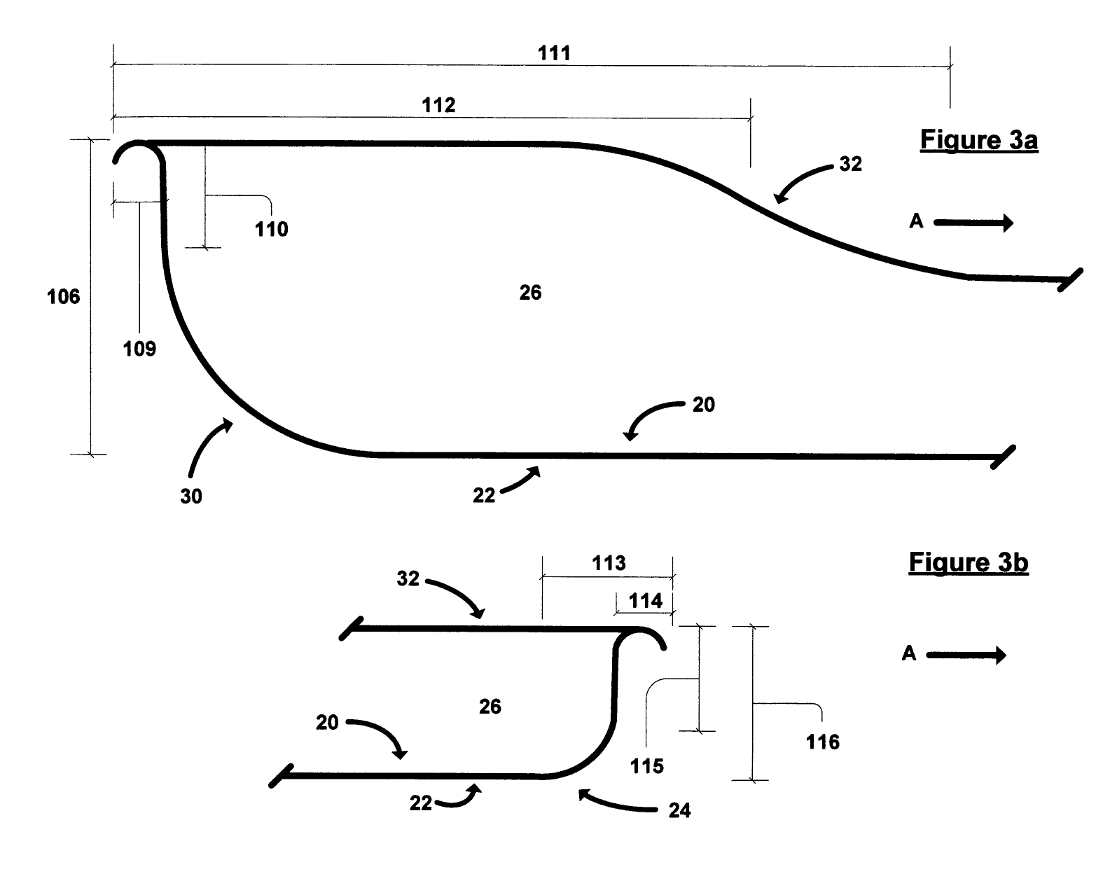

In a preferred construction of the invention, the concavely-shaped saucer body 12 is of a plastic composition, having a rounded seat section 20 with an underside 22. As will be understood by those skilled in the art, such underside 22 is fabricated to be substantially smooth so as to allow for the seat section 20 to essentially glide along the terrain when the transporter is being pulled. At a front area 24 of a side section 26 of the saucer body 12, a pair of adjacent through-extending apertures 28 are provided in the embodiment of FIGS. 1a and 1b for the rope 16 to allow a user to manually pull the saucer body 12 and any load that may be placed on its seat section 20. A back area 30 is provided, raised higher with respect to the seat section 20 than is the front area 24 to act as a “back-stop” to any tendency for a load to slide rearwardly as the saucer load transporter is being pulled in the direction shown by the arrow A. Because of the smooth underside to the seat section 20, pulling the hand-grip 18 in the direction of the arrow A slides the transporter along whatever terrain is encountered, in a “gliding” manner, and even up and over any curbs that might be encountered. By having the transporter rounded, the transporter 10 would just skate or snake around any obstruction it might hit in its path of movement. FIGS. 3a and 3b will be seen helpful in understanding the configuration of the transporter at its back and front areas 30 and 24, respectively.

While Applicant does not wish to be limited to any particular set of dimensions for this embodiment of the invention, the following have been found useful in one construction:

| | |
|---|---|
| Dimension 101 | 1′-10″ |
| Dimension 102 | 6″ |
| Dimension 103 | ½″ |
| Dimension 104 | 6″ |
| Dimension 105 | 2′-4″ |
| Dimension 106 | 3″ |
| Dimension 107 | ½″ |
| Dimension 108 | 1½″ |
| Dimension 109 | ½″ |
| Dimension 110 | 1″ |
| Dimension 111 | 8″ |
| Dimension 112 | 6″ |
| Dimension 113 | 1¼″ |
| Dimension 114 | ½″ |
| Dimension 115 | 1″ |
| Dimension 116 | 1½″ |
| Dimension 117 | 4′8″ |

As will be seen, the knotted rope 16 passes through the side section 26 at a point that is closer to the rounded seat section 20 than to the lip 32. The lip 32 will be appreciated to represent the height to which the side section 26 upwardly extends from the seat section 20. The saucer body 12 is preferably of a plastic composition and its knotted rope 16 composed of nylon so as to be strong, impervious to water and affording little breakage. The knotted rope 16 is shown passing through a first pair of spaced-apart points 27, 29 at the front area 24, via the through-extending apertures 28.

In the embodiment of FIGS. 2a and 2b, the rope 16 is also shown as passing through a second pair of spaced-apart points 31, 33 at the back area 30 of the side section 26, in the form of slotted, through-extending apertures 36. With this construction, that area of the saucer body 12 shown by the rope sections 16a and 16b allow for those rope sections to act to “tie-down” any load being transported. The slotted, through-extended apertures 36 are shown substantially diametrically opposite the through-extending apertures 28 of FIGS. 1a and 1b and may be individually spaced apart the same distance as the through-extending apertures 28, less than that distance, or greater than that distance. Where the load being transported is of a nature not necessary to be “tied-down”, the rope sections 16a and 16b of FIGS. 2a and 2b can simply be “slotted-out” from the apertures 36 and the rope 16 can be stretched from its length of Dimension 118 as shown in FIG. 2a to its doubled, or greater length of Dimension 117 as shown in FIG. 1a. In this respect, the Dimension 118 would be some 2′4″, when utilized with a saucer Dimension 105 of 2′4″.

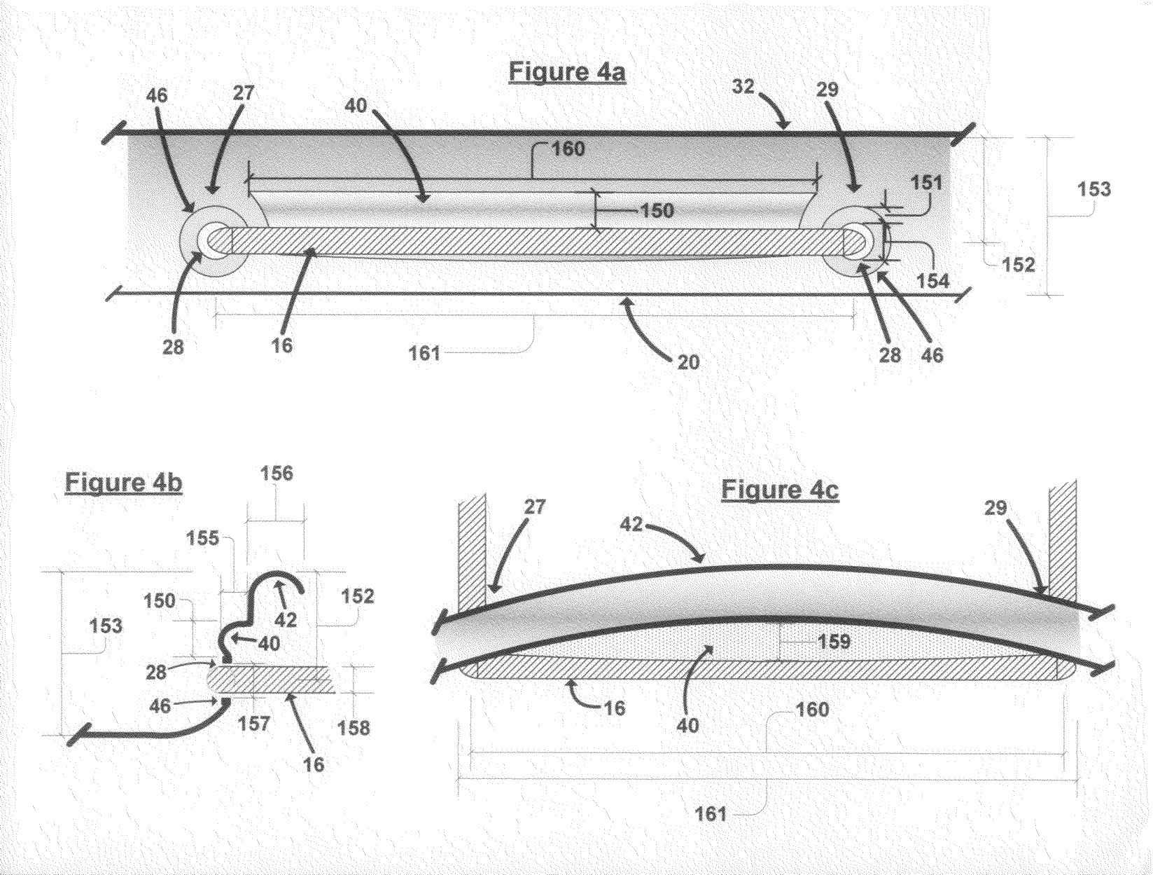

FIGS. 4a, 4b and 4c respectively illustrate inner view, side view and top view representations of the manner by which the knotted rope 16 passes the through-extending apertures 28 at the front area 24 of side section 26. The rope is shown at 16, the apertures are shown at 28, the lip is shown at 32 and the rounded seat is shown at 20. A brace 40 supported the rope 16 (FIG. 4a) and the lip 32 terminates in a rim 42. A pair of washers 46 encircle the apertures 28 in receiving the knotted rope, and could be separately added components or part of an integral construction of the side section 26 itself. With a nylon rope of ¼″ diameter, the following dimensions have proved useful in constructing the embodiments of the invention shown in FIGS. 1a & 1b and 2a & 2b:

| Dimension 150 | ⅜″ |
|---|---|
| Dimension 151 | ⅛″ |
| Dimension 152 | 1″ |
| Dimension 153 | 1½″ |
| Dimension 154 | ⅜″ |
| Dimension 155 | ¼″ |
| Dimension 156 | ½″ |
| Dimension 157 | ⅜″ |
| Dimension 158 | ¼″ |
| Dimension 159 | ¼″ |
| Dimension 160 | 5⅜″ |
| Dimension 161 | 6″ |

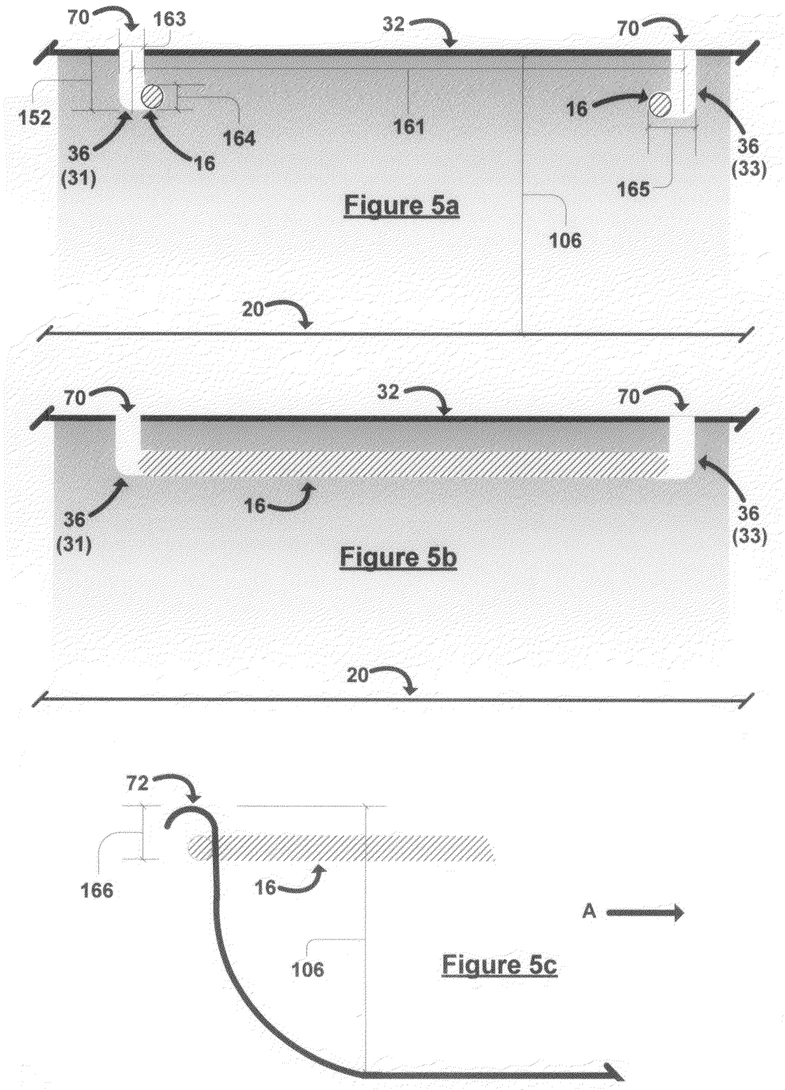

FIGS. 5a, 5b and 5c respectively illustrate an inside view, outside view and side view of back area 30 of the saucer load transporter of FIGS. 2a and 2b. The slotted, through-extending apertures 36 are shown with the knotted rope 16 in its “tie-down” position within the slot. When the “tie-down” is to be released, the rope 16 is moved outwardly (i.e. to the side in the Drawing), into a channel 70 (FIG. 5a). The lip 32 is shown in each of FIGS. 5a and 5b, as is the rounded seat section 20. A rim 72 is included similar to the rim 42 at the front area (FIG. 4b) and the raised back area 30 is represented by the Dimension 106. The following dimensions have proved useful in this construction:

| | |
|---|---|
| Dimension 162 | ⅝″ |
| Dimension 163 | ¼″ |
| Dimension 164 | ¼″ |
| Dimension 165 | ½″ |
| Dimension 166 | ⅝″ |

Again, the raised back area 30 restricts the load being carried from sliding off the seat 20 when the saucer load transporter is being pulled.

Whereas there have been described what are considered to be preferred embodiments of the present invention, it will be readily appreciated by those skilled in the art that modifications can be made without departing from the scope of the teachings herein. Thus, for example, while the invention has been described in the context of transporting cumbersome objects over certain described terrain and up-and-over curb emplacements, it will be noted that the saucer load transporter could also be utilized for moving loads over snow as well—as an alternative to carrying cut firewood from a wood stack over the snow. The smooth underside of the body seat will allow the saucer to glide over the snow when pulled, and to skate and snake around any objects that it might otherwise come in contact with. While described as preferably being of a plastic composition, the concavely-shaped saucer body could be fabricated instead to take on the contour of a rounded metal tray. In any event, by tying the rope at adjacent points on the front end, with or without a raised back area to “back-stop” any of the load from falling off rearwardly when being pulled, the embodiments of the invention clearly indicate the benefits to be derived by having a transporter arrangement which “glides” over the terrain, rather than one which is pushed and pulled in the configuration of a wheelbarrow, along with its attendant disadvantages. For all such reasons, therefore, resort should be had to the claims appended hereto for a true understanding of the invention

What is claimed is:

1. A saucer load transporter comprising: a concavely-shaped saucer body having a rounded seat section with an underside for engaging a terrain to be traversed, an upwardly extending, substantially surrounding side section forming a lip to restrict movement of a load to be transported on said seat section; and a rope extension arrangement connected at a first pair of adjacent points on said side section for a user to manually pull the saucer body and its load.

2. The saucer load transporter of claim 1 wherein the rope extension arrangement includes a tubular grip through which a rope extends.

3. The saucer load transporter of claim 2 wherein the tubular grip is of a length equal to at least 2 hand-spans of the user.

4. The saucer load transporter of claim 2 wherein the rope is of a nylon composition.

5. The saucer load transporter of claim 2 wherein the concavely-shaped saucer body is of a plastic composition.

6. The saucer load transporter of claim 1 wherein the rounded seat section has a smooth underside.

7. The saucer load transporter of claim 1 wherein the rope extension arrangement is connected along the side section at a location closer to the rounded seat section than to the lip.

8. The saucer load transporter of claim 7, also including a second pair of adjacent points on said side section substantially diametrically opposite to said first pair of adjacent points.

9. The saucer load transporter of claim 8 wherein the second pair of adjacent points are spaced further apart than are the first pair of adjacent points.

10. The saucer load transporter of claim 9 wherein the first pair of adjacent points include through-extending apertures formed in the side section, and wherein the second pair of adjacent points include slotted, through-extending apertures formed in the side section.

11. The saucer load transporter of claim 10 wherein the rope extension arrangement is connected through the first and second pairs of adjacent points.

12. The saucer load transporter of claim 10 wherein the side section extends higher towards the lip at the location where the slotted, through-extending apertures are formed than where the through-extending apertures are formed.

13. The saucer load transporter of claim 12 wherein the rope extension arrangement includes a tubular grip through which a rope knotted at its ends extends.

14. The saucer load transporter of claim 12 wherein the rope extension arrangement includes a tubular grip through which a rope extends, wherein the rope is of a nylon composition, and wherein the concavely-shaped saucer body is of a plastic composition.

15. The saucer load transporter of claim 12 wherein the rounded seat section is of a substantially 2 foot, 4 inch diameter; wherein the side section where the slotted, through-extending apertures are formed extends to the lip of a length of 3 inches with respect to the rounded seat section, and wherein the side section where the through-extending apertures are formed extends a height of 1½ inches measured with respect to the rounded seat section,

16. The saucer load transporter of claim 1 wherein the rounded seat section is of a substantially 2 foot, 4 inch diameter.

17. The saucer load transporter of claim 1 wherein the side section extends to the lip a length of 3 inches with respect to the rounded seat section.
